(19) United States
(12) Patent Application Publication
(10) Pub. No.: US 2026/0149638 A1
(43) Pub. Date: May 28, 2026

(54) System and a Method for Determining an Optimal Network Configuration for a Communication Network

(71) Applicant: ABB Schweiz AG, Baden (CH)

(72) Inventors: Sameer Chouksey, Bengaluru (IN); Pablo Rodriguez, Birkenau (DE); Subhash Kumar, Bokaro (IN)

(73) Assignee: ABB Schweiz AG, Baden (CH)

(21) Appl. No.: 19/453,200

(22) Filed: Jan. 20, 2026

Related U.S. Application Data
(63) Continuation of application No. PCT/IB2024/054883, filed on May 20, 2024.

(30) Foreign Application Priority Data
Jul. 21, 2023 (IN) 202341049247

(51) Int. Cl. H04L 41/0823; H04L 41/00; H04L 41/16

(52) U.S. Cl. CPC H04L 41/0823; H04L 41/16; H04L 41/20

(57) ABSTRACT

A system and method for determining an optimal network configuration for a communication network includes receiving an input request comprising a network topology and a communication intent, determining one or more network performance requirements and one or more data paths based on the communication intent and the network topology, extracting at least one historic network configuration related to the communication intent, the network topology and at least one of the one or more network performance requirements, from a configuration database; determining an optimal network configuration based on the at least one historic network configuration, for enabling communication between the plurality of devices through at least one or more data paths, and automatically generating and validating network configuration in a communication network without any manual intervention.

### CROSS-REFERENCE TO RELATED APPLICATIONS

The instant application claims priority to International Patent Application No. PCT/IB2024/054883, filed May 20, 2024, and to Indian Patent Application number 202341049247, filed Jul. 21, 2023, each of which is incorporated herein in its entirety by reference.

### FIELD OF THE DISCLOSURE

The present disclosure generally relates to computer networking and, more particularly, to a system and a method for determining an optimal network configuration for a communication network.

### BACKGROUND OF THE INVENTION

Industrial plants run on complex networks. These complex networks may be formed based on various components such as network switches, routers, end devices, firewalls, and the like. Further, with deployment of Information technology or Operational technology, these networks evolve to have different network topology and communication flow varying from one industrial plant to another industrial plant. To suitably configure these networks, for successful communication of data from device A to device B within the industrial plant, there is a need to determine the communication flow between nodes in the industrial plant along with optimal network performance parameters such as data-rate, latencies, reliability, and other Quality of Service (QoS) properties.

In the conventional systems, the networks are configured manually, which is time consuming and error prone. For instance, while configuring a network A, it is required to manually determine number of network switches and the network topology, which is time consuming and may be inaccurate. Further, these manual configurations lack domain knowledge and may not be able to accurately determine what network parameters may be required for the network configuration to successfully transfer the data between the network devices in less time.

### BRIEF SUMMARY OF THE INVENTION

The present disclosure generally describes a system and method for determining an optimal network configuration for a communication network.

In one embodiment, the present disclosure provides a method of determining an optimal network configuration for a communication network. The method comprises receiving, by a network configuration system, an input request comprising a network topology and a communication intent for facilitating communication between a plurality of devices. Further, the method comprises determining, by the network configuration system, one or more network performance requirements and one or more data paths based on the communication intent and the network topology. Furthermore, the method comprises extracting, by the network configuration system, at least one historic network configuration related to the communication intent, the network topology and at least one of the one or more network performance requirements, from a configuration database associated with the network configuration system. Thereafter, using an Artificial Intelligence (AI) based model, the method comprises determining, by the network configuration system, an optimal network configuration based on the at least one historic network configuration, for enabling communication between the plurality of devices through at least one of the one or more data paths, in accordance with the communication intent and the one or more network performance requirements.

In another embodiment, the present disclosure comprises a network configuration system for determining an optimal network configuration for a communication network. The network configuration system comprises a processor and a memory. The memory stores processor-executable instructions, which, on execution, causes the processor to receive an input request comprising a network topology and a communication intent for facilitating communication between a plurality of devices. Further, the processor is configured to determine one or more network performance requirements and one or more data paths based on the communication intent and the network topology. Further, the processor is configured to extract at least one historic network configuration related to the communication intent, the network topology and at least one of the one or more data paths and the one or more network performance requirements, from a configuration database associated with the network configuration system. Thereafter, using an Artificial Intelligence (AI) based model, the processor is configured to determine an optimal network configuration based on the at least one historic network configuration, for enabling communication between the plurality of devices through at least one of the one or more data paths, in accordance with the communication intent and the one or more network performance requirements.

### BRIEF DESCRIPTION OF THE SEVERAL VIEWS OF THE DRAWING(S)

FIG. 1 depicts a schematic representation of an environment for determining an optimal network configuration for a communication network, in accordance with embodiments of the present disclosure.

FIG. 2A illustrates a block diagram of a network configuration system for determining an optimal network configuration for a communication network, in accordance with embodiments of the present disclosure.

FIG. 2B depicts an exemplary network performance requirements generated by the network configuration system of FIG. 1, in a communication network, in accordance with some embodiments of the present disclosure.

FIG. 2C depicts an exemplary data path defined by the network configuration system of FIG. 1, in accordance with some embodiments of the present disclosure.

FIG. 3 depicts a flowchart illustrating a method of determining an optimal network configuration for a communication network, in accordance with embodiments of the present disclosure.

FIG. 4 illustrates a block diagram of an exemplary computer system for implementing embodiments consistent with the present disclosure.

### DETAILED DESCRIPTION OF THE INVENTION

Industrial plants run on complex networks. These complex networks may be formed based on various components such as network switches, routers, end devices, firewalls, and the like. In order to suitably configure these networks, for successful communication of data from device A to device B within the industrial plant, there is a need to determine the communication flow between nodes in the industrial plant along with optimal network performance parameters. In the conventional systems, the networks are configured manually, which is time consuming and error prone. Further, these manual configurations lack domain knowledge and may not be able to accurately determine what network parameters may be required for the network configuration to successfully transfer the data between the network devices in less time.

The present disclosure describes a system and a method for determining an optimal network configuration for a communication network. In some embodiments, the present disclosure may relate to a network configuration system enabled to determine an optimal network configuration for a communication network using an Artificial Intelligence (AI) based model. To determine the optimal network configuration, the present disclosure may be configured to generate a feasible network configuration based on at least one historic network configuration that is in accordance with a communication intent, data paths, one or more network performance requirements etc., or in other words, the historic network configuration which has a similar communication intent, data paths, and the one or more network performance requirements. Thereafter, the present disclosure may be configured to validate if network performance output of the feasible network configuration achieved in real-time is compliant with an expected network performance for the communication intent. If the network performance output is validated to be compliant with the expected network performance, the feasible network configuration is inferred as the optimal network configuration. However, if the network performance output is validated to be not compliant with the expected network performance, the feasible network configuration is rejected and the method of generating and validating the feasible network configuration is iterated until a subsequent feasible network configuration is compliant with the expected network performance.

The present disclosure aims to automatically generate and validate network configuration in a communication network without any manual intervention, thereby leading to determining an accurate network configuration in less time in order to achieve a communication intent.

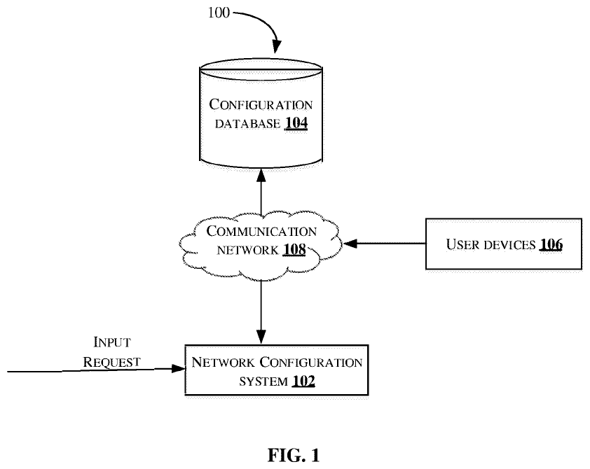

FIG. 1 depicts a schematic representation of an environment (100) for determining an optimal network configuration for a communication network, in accordance with embodiments of the present disclosure.

The environment (100) includes a network configuration system (102), a configuration database (104), and one or more user devices (hereinafter referred to as devices) (106) communicatively coupled via a communication network (108). The communication network (108) may be one of, a wired communication network, a wireless communication network or a combination of both wired and wireless communication network. The communication network (108) may comprise the one or more devices (106) connected with each other via one or more network devices such as switch, hub, gateway, router and the like to enable communication of data from one user device to another user device. For example, one user device may be a camera, and another user device may be a monitor to display the images captured by the camera.

The network configuration system (102) may determine an optimal network configuration for facilitating communication between the plurality of devices (106). To facilitate the communication between plurality of devices (106), the network configuration system (102) may receive an input request from one or more devices associated with one or more network operators or network administrators. The input request may include, but not limited to, a network topology and a communication intent. The communication intent is a high-level requirement of the network operator for facilitating communication between the plurality of devices. For instance, a communication intent may be sending an image data from device A to the device B in 400 milliseconds in a given network topology.

Upon receiving the input request, the network configuration system (102) may determine one or more network performance requirements based on the communication intent and one or more data paths defined based on the network topology. The one or more network performance requirements may be requirements set by the network operators to achieve the communication intent between the plurality of devices (106). In one example, the network configuration system (102) may determine the one or more network performance requirements such as, but not limited to, latency, priority, bandwidth, jitter, redundancy and segregation requirements of a communication network. The network configuration system (102) further defines one or more data paths that may indicate different routes established between the plurality of devices (106) to achieve the communication intent.

Furthermore, the network configuration system (102) may extract at least one historic network configuration related to the communication intent, the network topology and at least one or more data paths and the one or more network performance requirements from the configuration database (104). In other words, the network configuration system (102) may extract at least one historic network configuration that is implemented for similar communication intent, and network topology and at least one or more data paths and the one or more network performance requirements as that of the given communication intent, and network topology and at least one or more data paths and the one or more network performance requirements, from the configuration database (104). In the context of the present disclosure, “similar” could be any network configuration which has at least one of common communication intent, or a common data path considered as per the communication intent, or a common expected network performance, with respect to the given communication intent, network topology and expected network performance. Further, “similar” could be any network configuration which may be partially compliant or fully compliant with the expected network performance for the given communication intent. For example, consider the communication intent is to share an image data from device A to device B in 100 milliseconds. If an exemplary historic network configuration 1 ensures sharing text data from device A to device B in 50 milliseconds, then the historic network configuration 1 may be considered as a similar network configuration for the given communication intent, due to the commonalities i.e., the devices between which the communication is occurring, and the intention of sharing data within a desired time limit between the devices. In some embodiments, the network configuration system (102) may detect the historic network configurations that are similar to the given communication intent, the network topology and at least one or more data paths and the one or more network performance requirements by using, without limitation, predefined techniques that estimate distance between vector representation of each network configuration and selecting the network configuration based on the least distance. As an example, one such predefined technique may be a K-means technique that enables determining historic network configurations that have similarities with respect to the given communication intent, the network topology and at least one or more data paths and the one or more network performance requirements. In some embodiments, the network configuration system (102) may apply the predefined technique on all the historic network configurations stored in the configuration database (104). In some other embodiments, the network configuration system (102) may initially apply a filter to fetch the historic network configurations that involve communication between the devices that are same as the devices mentioned in the given communication intent, and then apply the predefined technique on the filtered historic network configurations. In yet other embodiments, the network configuration system (102) may use, without limitation, any other known or predefined technique to detect the historic network configuration similar to the given communication intent, the network topology and at least one or more data paths and the one or more network performance requirements.

In some embodiments, the configuration database (104) may store content that includes a plurality of historic network configurations related to one or more previously requested communication intent and the corresponding network performance requirements, the one or more data paths, and the network performance output. The plurality of historic network configurations may be generated based on tested network performance requirements and data paths for a plurality of tested communication intents, that may be generated based on simulation and stored in the configuration database (104) before real-time deployment of the configuration database (104). As illustrated in FIG. 1, the configuration database (104) is communicatively coupled to the network configuration system (102) via the communication network (108). In another embodiment, the configuration database (104) may be integrated within the network configuration system (102).

Upon extracting the at least one historic network configuration, the network configuration system (102) may generate a feasible network configuration in accordance with the communication intent and the one or more network performance requirements using an Artificial Intelligence (AI) based model based on the at least one historic network configuration extracted from the configuration database (104). In some embodiments, the feasible network configuration may be a network configuration having a probability of being compliant with the expected network performance for a given communication intent and a network topology. However, all feasible network configurations that are generated may not be able to comply with the expected network performance. In some embodiments, when more than one historic network configuration is extracted from the configuration database (104) on similarity basis as explained above, one or more feasible network configurations may be generated from each historic network configuration. In some other embodiments, when more than one historic network configuration is extracted from the configuration database (104) on similarity basis as explained above, one or more feasible network configurations may be generated by correlating and/or combining one or more historic network configurations. Therefore, upon determining the feasible network configuration, the network configuration system (102) may validate the feasible network configuration to check if a network performance output achieved using the feasible network configuration is compliant with an expected network performance for the communication intent. If the network performance output is validated to be compliant with the expected network performance, the network configuration system (102) may infer the feasible network configuration as the optimal network configuration, and may enable communication between the plurality of devices through at least one of the one or more data paths, in accordance with the communication intent and the one or more network performance requirements using the optimal network configuration. In some embodiments, if the network configuration system (102) validates that the network performance output is not compliant with the expected network performance, then, the network configuration system (102) may reject the feasible network configuration and iterate the steps of generating and validating until the network configuration system (102) determines a subsequent feasible network configuration that is compliant with the expected network performance for the communication intent. In some embodiments, even the rejected feasible network configuration may be stored in the configuration database (104) against that communication intent along with an indication that it was unable to meet the expected result as per the communication intent. In some embodiments, such network configurations could be useful for generating a feasible network configuration for a different communication intent. Therefore, in summary, each feasible network configuration may be validated to reject those which fail to comply with the expected network performance and to retain those that comply with the expected network performance to determine the optimal network configuration for the given communication intent and the network topology. The aspect of validation and how the optimal network configuration is determined among the feasible network configurations is explained in detail in the further sections of the present disclosure.

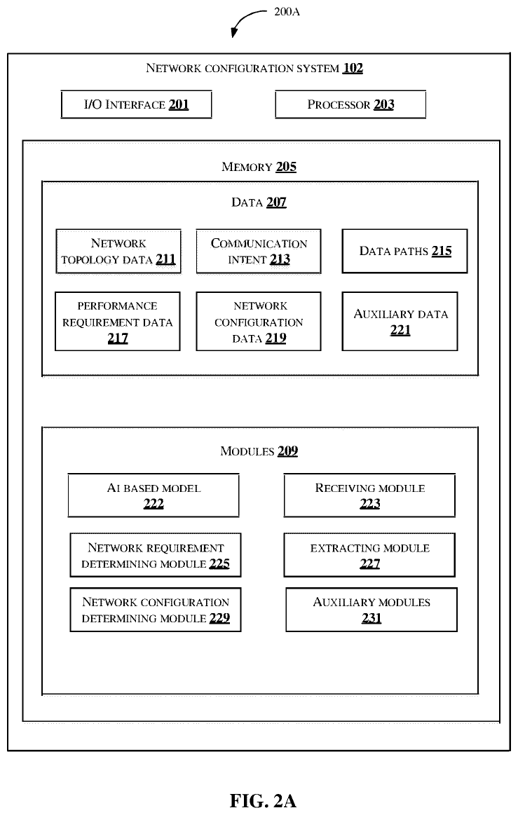

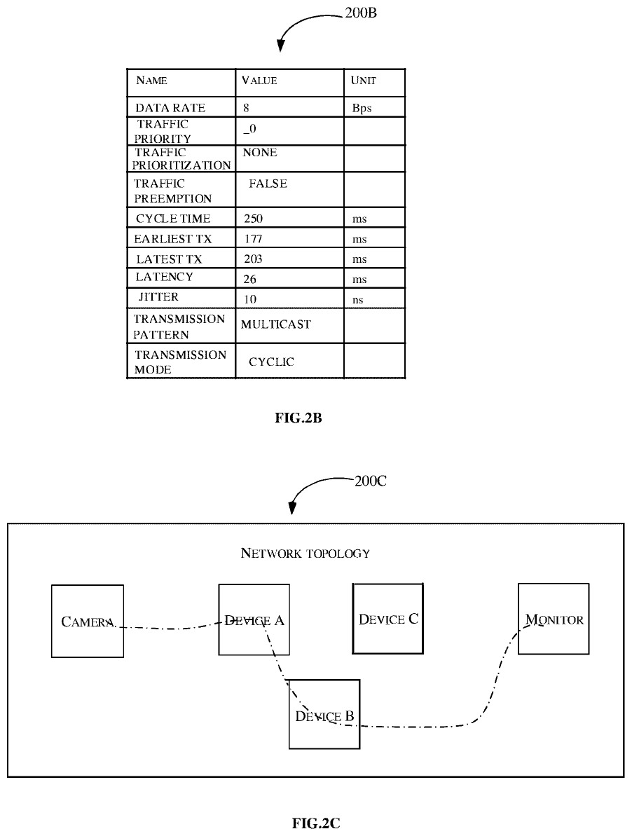

FIG. 2A depicts a block diagram (200A) of a network configuration system (102) for determining an optimal network configuration for a communication network, in accordance with embodiments of the present disclosure.

In some embodiments, the network configuration system (102) may include an Input/Output (I/O) interface (201), a processor (203) and a memory (205). The I/O interface (201) may be configured for receiving and transmitting an input signal or/and an output signal related to one or more operations of the network configuration system (102). The memory (205) may be communicatively coupled to the processor (203) and one or more modules (209). The processor (203) may be configured to perform one or more functions of the network configuration system (102) using data (207) and the one or more modules (209).

In an embodiment, the data (207) stored in the memory (205) may include without limiting to, network topology data (211), communication intent (213), data paths (215), performance requirement data (217), network configuration data (219) and auxiliary data (221). In some implementations, the data (207) may be stored within the memory (205) in the form of various data structures. Additionally, the data (207) may be organized using data models. The auxiliary data (221) may include various temporary data and files generated by the different components of the network configuration system (102).

In one example, the processor (203) receives the network topology data (211) as part of the input request from a network operator to perform the communication intent (213). The network topology data (211) may include a network topology for facilitating communication between the plurality of devices (106) and achieve the communication intent (213). The network topology data (211) may be defined as an arrangement of user devices and/or network devices in a communication network. For instance, a layout of arrangement of computing devices such as laptop and mobile devices connected to a wireless modem for accessing Internet is an example of a star network topology. The processor (203) also receives the communication intent (213) as input from the network operator. The communication intent (213) may be defined as a high-level requirement in facilitating communication between the plurality of devices (106). For example, in an industrial plant A, the communication intent (213) may be to send image and video data from a camera A to monitor A, monitor B and monitor C within 700 milliseconds. Based on the communication intent (213) and the network topology data (211), the processor (203) generates the data paths (215) and the performance requirement data (217) required for example, to send the image and video data from the camera A to the monitor A.

In one embodiment, the data paths (215) define a number of paths or routes used for transmitting data between the plurality of devices (106). The data paths (215) may be determined based on the network topology data (211). For example, for sending data between device A and device B, a data path A and a data path B may be identified. The data path A is a path where the data is configured to be transmitted after passing through five switches involving a high latency. The data path B is a path where data is configured to be transmitted after passing through three switches with a low latency. To achieve the communication intent for example, sending video data from device A to device B with low latency, the processor (203) identifies the data path B that has a faster route as compared to data path A because of presence of lesser number of devices and achievement of low latency. The processor (203) also generates the performance requirement data (217) required to achieve the communication intent (213).

The performance requirement data (217) may include network performance requirements for facilitating communication between the plurality of devices (106). The one or more network performance requirements may be requirements to achieve the communication intent (213) between the plurality of devices. The one or more network performance requirements may include, but not limited to, latency, priority, bandwidth, jitter, redundancy and segregation requirements of a communication network. For example, the latency indicates the time taken for a data packet to travel from one device to another device. The longer the distance between the plurality of devices, the higher is the latency. Another exemplary network performance requirement is the priority that may include but not limited to a priority of traffic. For example, the priority may be one of a high priority, a medium priority and a low priority. In an example, high priority assigned to a data A indicates that the data A has to be sent at any cost, while suspending the other data traffic through the network. Yet another exemplary network performance requirement is the bandwidth which indicates the amount of information to be shared between devices in a given amount of time. For example, if a bandwidth is determined to be 60 Mbps in the communication network, then the data packets between the plurality of devices in the communication network cannot be transmitted faster than 60 Mbps. Yet another exemplary network performance requirement is the jitter which is a variation in latency obtained when data packets take a longer time to transfer from device A to device B. Another exemplary network performance requirement is the redundancy that includes alternative data paths for facilitating communication between plurality of devices if the communication between the plurality of devices fails using a particular data path. Yet another exemplary network performance requirement is the segregating requirements which are type of requirements determined for sending data accurately from a device A to a correct destination device B. Based on the data paths (215) and the performance requirement data (217), the processor (203) generates the feasible network configurations using the AI based model.

In some embodiments, the network configuration data (219) may include without limitation, at least one historic network configuration extracted from the configuration database (104), a feasible network configuration, and an optimal network configuration. In some embodiments, the feasible network configuration may be a network configuration having a probability of being compliant with the expected network performance for a given communication intent (213) and a network topology. However, all feasible network configurations that are generated may not be able to comply with the expected network performance. In some embodiments, the feasible network configuration is generated based on the at least one historic network configuration extracted from the configuration database (104). The at least one historic network configuration may be a network configuration that is implemented for similar communication intent, and network topology and at least one of, one or more data paths (215) and the one or more network performance requirements as that of the given communication intent (213), and network topology and at least one of, one or more data paths (215) and the one or more network performance requirements. The optimal network configuration is the feasible network configuration which achieves a network performance output that is compliant with an expected network performance for the given communication intent (213) and network topology. In some embodiments, a plurality of historic network configuration stored in the configuration database (104) may be generated based on simulated network performance requirements and the data paths (215) for a plurality of simulated communication intents. In some embodiments, the historic network configuration may be previously stored within the network configuration system (102) in the memory (205). The network configuration data (219) is stored in the configuration database (104) for the AI based model to self-learn for enhanced prediction of another optimal network configuration in future for another type of communication intent (213). For instance, consider a communication intent 2 sends video data from device A to device B within 300 milliseconds. Consider, the historic network configurations include a network configuration X and network configuration Y. The network configuration X enables sending image data from device A to device B within 375 milliseconds in the past for the communication intent 1 and the network configuration Y enables sending image data from device A to device B within 399 milliseconds in the past for the same communication intent 1. In the present example, the processor (203) determines both the network configuration X and Y to be related to, or in other words, similar to a network configuration that may be required for achieving the communication intent 2 as the network configuration X and Y consider communication between the devices A and B that are same as the devices mentioned in the communication intent 2, and also share data between devices A and B in a certain time limit which is close to the time limit mentioned in the communication intent 2. Therefore, the network configuration X and Y would be both extracted and considered for generating feasible network configurations for the communication 2.

As explained above, the processor (203) and the one or more modules (209) of the network configuration system (102) process the data (207) to achieve the communication intent (213). In an implementation, the one or more modules (209) may include, without limiting to, an AI based model (222), a receiving module (223), a network requirement determining module (225), an extracting module (227), a network configuration determining module (229), and auxiliary modules (231). In an embodiment, the auxiliary modules (231) may be used to perform various miscellaneous functionalities of the network configuration system (102). It will be appreciated that such one or more modules (209) may be represented as a single module or a combination of different modules.

In some embodiments, the receiving module (223) may be configured to receive the input request comprising the network topology data (211) and a communication intent (213) for facilitating communication between the plurality of devices (106). In some embodiments, the network requirement determining module (225) may be configured to determine the one or more network performance requirements and the one or more data paths (215) based on the communication intent (213) and the network topology data (211).

In some embodiments, the extracting module (227) may be configured to extract one historic network configuration related to the communication intent (213), the network topology and at least one of the one or more data paths (215) and the one or more network performance requirements, from the configuration database (104). The configuration database (104) comprises a plurality of historic network configurations and the corresponding network performance requirements for the communication intent (213). An exemplary entry in the configuration database (104) may be as shown in the below Table 1.

TABLE 1

| | Network | | Data | | | |
|---|---|---|---|---|---|---|
| Sl. | configuration | Devices | paths | N/W perf. | | Network |
| no | (NC) | involved | involved | reqmts. | Topology | perf. output |
| 1. | NC- P | A, B | Data | Latency: | Star | Image data |
| | | | path - 5 | 20 ms | topology | shared |
| | | | between | Data rate: | | between A |
| | | | A and B | 7 Bps | | and B in 360 |
| | | | | Jitter: 10 ns | | milliseconds |
| 2. | NC- Q | A, C | Data | Latency: | Star | Video data |
| | | | path - 2 | 22 ms | topology | shared |
| | | | between | Bandwidth: | | between A |
| | | | A and C | 15 Bps | | and C in 450 |
| | | | | Jitter: 12 ns | | milliseconds |

In some embodiments, the network configuration determining module (229) may be configured to determine the optimal network configuration based on at least one historic network configuration for enabling communication between the plurality of devices (106) through at least one of the one or more data paths (215) that is in accordance with the communication intent (213) and the one or more network performance requirements. To determine the optimal network configuration, the network configuration determining module (229) may be configurated to generate the feasible network configuration based on at least one historic network configuration extracted from the configuration database (104) using the AI based model (222). Furthermore, the network configuration determining module (229) may validate if network performance output achieved in real-time using the feasible network configuration is compliant with an expected network performance for the communication intent (213). If the network performance output is validated to be compliant with the expected network performance, then the network configuration determining module (229) may infer the feasible network configuration as the optimal network configuration for enabling communication between the plurality of devices through at least one of the one or more data paths (215), in accordance with the communication intent (213) and the one or more network performance requirements. In some other embodiments, if the network performance output is validated to be not compliant with the expected network performance, then the network configuration determining module (229) may reject the feasible network configuration and iterate the steps of generating, and validating until the determination of a subsequent feasible network configuration is compliant with the expected network performance for the communication intent (213).

In one exemplary embodiment, the AI based model (222) uses a reinforcement learning technique for self-learning based on the content stored in the configuration database (104) through every iteration involved in determining the optimal network configuration for the communication intent (213). The content may include, but not limited to, the historic network configurations along with the corresponding communication intent (213), the one or more network performance requirements, one or more data paths (215), and the network performance output as shown above in the exemplary Table 1. Further, the content may include, but not limited to, at least one of the feasible network configuration generated for each iteration involved in determining the optimal network configuration and the optimal network configuration in the configuration database (104), along with the corresponding communication intent (213), the one or more network performance requirements, one or more data paths (215), and the network performance output. Further, in some exemplary embodiments, the AI based model (222) may be any other supervised or unsupervised machine learning model that self-learns based on the content stored in the configuration database (104). The machine learning model, may include, but not limited to, rule augmented AI model, foundation models and neuro-symbolic AI models. In some embodiments, the AI based model (222) may be implemented in the network configuration system (102) as shown in the FIG. 2A. In some other embodiments, the AI based model (222) may be implemented in a different entity which is locally connected to the network configuration system (102) or in a remote server or a cloud infrastructure and wirelessly connected to the network configuration system (102).

Thereafter, the network configuration determining module (229) may be configured to implement the optimal network configuration in the communication network so as to achieve the communication intent (213) in the given network topology.

Henceforth, the process of determining an optimal network configuration for a communication network is explained with the help of one or more examples for better understanding of the present disclosure. However, the one or more examples should not be considered as limitation of the present disclosure.

Consider a scenario in an industrial setup, wherein device P and device Q are located within an industrial plant. For example, the device P is a camera and the device Q is a monitor. The network configuration system (102) receives an input request I from a computing device with communication intent CI and given network topology NT. The communication intent CI includes sending an image data from the camera to the monitor in 500 milliseconds, which is the expected network performance output. Consider the 500 ms output may be acceptable with a buffer of 5 milliseconds. The network topology NT comprises the arrangement of the camera and the monitor being connected to plurality of devices in a bus network. Now, the network configuration system (102) determines network performance requirements based on the communication intent CI. The network performance requirements NPR is exemplified in FIG. 2B.

To achieve the communication intent CI, the network performance requirements NPR comprises a data rate of 8Bps, no requirement of traffic pre-emption, a cycle time of 250 ms, an earliest TX of 177 ms and a latest TX of 203 ms, latency of 26 ms, and jitter of 10 ns. The transmission pattern has to be multicast and transmission mode has to be cyclic. A data path DP is determined based on the network topology NT. The data path DP includes sending an image data from a camera to monitor by passing through devices A and B with latency of 26 ms. An exemplary network topology NT is depicted in FIG. 2C. The dotted lines in the FIG. 2C represents the data path DP. Now, the network configuration system (102) extracts historic network configurations which are similar to the communication intent CI from the configuration database (104) based on the network performance requirements NPR and the data path DP. Consider that, based on one of the historic network configuration HNC-1, the network configuration system (102) generates a feasible network configuration FNC-1 using the AI based model (222). The feasible network configuration FNC-1 includes network performance requirements NPR-1 comprising a data rate of 12 Bps, no requirement of traffic pre-emption, a cycle time of 190 ms, an earliest TX of 175 ms and a latest TX of 210 ms, latency of 30 ms, jitter of 10 ns. Thus, the feasible network configuration FNC-1 enables sending the image data from the camera to the monitor in 700 milliseconds based on the network performance requirements NPR-1. The network configuration system (102) validates if the network performance output of the feasible network configuration FNC-1 achieved in real-time is complaint with the expected network performance output. If the network configuration system (102) determines that the network performance output of the feasible network configuration FNC-1 achieved in real-time is complaint with the expected network performance output, the network configuration system (102) infers the feasible network configuration FNC-1 as an optimal network configuration for the communication intent CI.

If the network configuration system (102) validates the network performance output of the feasible network configuration FNC-1 achieved in real-time is not complaint with the expected network performance output, the network configuration system (102) generates another feasible network configuration FNC-2 based on the same historic network configuration HNC-1 or a different historic network configuration HNC-2. As the network performance output of FNC-1 resulted in sharing data from camera to monitor in 700 ms which is not in compliance with the expected network performance, the network configuration system (102) proceeds to validate the generated FNC-2. Consider that the FNC-2 considers the network performance requirements NPR-2 data rate of 10Bps, no requirement of traffic pre-emption, a cycle time of 500 ms, an earliest TX of 177 ms and a latest TX of 207 ms, latency of 24 ms, jitter of 7 ns. Consider, the feasible network configuration FNC-2 enables sending the image data from the camera to the monitor in 497 milliseconds based on the network performance requirements NPR-2. As the network performance output of 497 milliseconds is less than the expected network performance of 500 ms, the feasible network configuration FNC-2 would be inferred as optimal network configuration for the communication intent CI.

In some embodiments, consider a scenario where initially when the network configuration system (102) extracts historic network configurations from the configuration database (104) on similarity basis, a historic network configuration that complies with the expected network performance of the given communication intent and network topology is detected. The network configuration system (102) may extract and use the historic network configuration directly to implement the action required according to the communication intent. For instance, in the above example, consider when the network configuration system (102) performed a similarity search in the configuration database (104), a historic network configuration which has been implemented earlier to communicate data from camera to monitor in 490 milliseconds was detected. The expected network performance was 500 ms, however, the configuration database (104) already comprises a historic network configuration which enables the communication as per the communication intent in time lesser than the expected time of 500 ms. Hence, the detected historic network configuration would be inferred as the optimal network configuration and used for communication between the camera and the monitor.

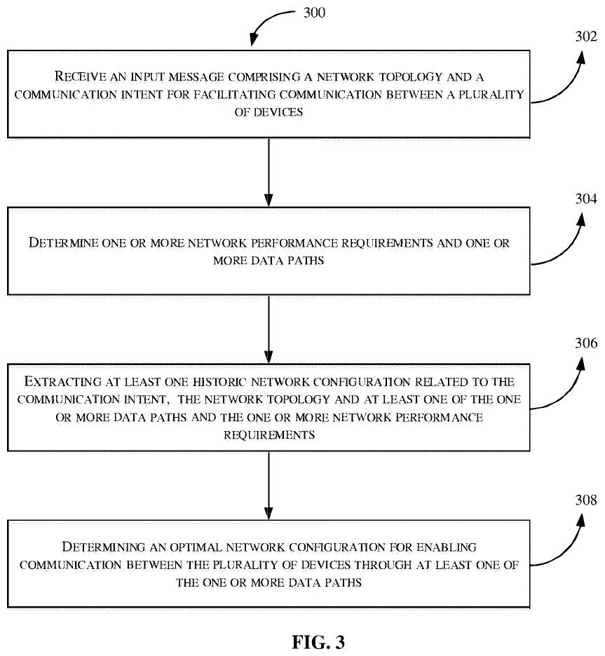

FIG. 3 depicts a flowchart illustrating a method determining an optimal network configuration for a communication network, in accordance with embodiments of the present disclosure. As illustrated in the FIG. 3, the method (300) includes one or more blocks illustrating the method (300) determining an optimal network configuration for a communication network. The method (300) may be described in the general context of computer executable instructions. Generally, computer executable instructions can include routines, programs, objects, components, data structures, procedures, modules, and functions, which perform functions or implement abstract data types.

The order in which the method (300) is described is not intended to be construed as a limitation, and any number of the described method blocks can be combined in any order to implement the method (300). Additionally, individual blocks may be deleted from the methods without departing from the spirit and scope of the subject matter described herein. Furthermore, the method (300) can be implemented in any suitable hardware, software, firmware, or combination thereof.

At block 302, the method (300) includes receiving, by a network configuration system (102), an input request comprising a network topology and a communication intent (213) for facilitating communication between a plurality of devices.

At block 304, the method (300) includes determining, by the network configuration system (102), one or more network performance requirements and one or more data paths (215) based on the communication intent (213) and the network topology.

At block 306, the method (300) includes extracting, by the network configuration system (102) at least one historic network configuration related to the communication intent (213), the network topology and at least one of the one or more data paths (215) and the one or more network performance requirements, from a configuration database (104) associated with the network configuration system (102).

At block 308, the method (300) includes determining, by the network configuration system (102), an optimal network configuration using an Artificial Intelligence (AI) based model based on the at least one historic network configuration, for enabling communication between the plurality of devices through at least one of the one or more data paths (215), in accordance with the communication intent (213) and the one or more network performance requirements. Further, to determine the optimal network configuration, the method (300) includes generating by the network configuration system (102), a feasible network configuration based on at least one of the historic network configuration extracted from the configuration database (104), in accordance with the communication intent (213) and the one or more network performance requirements, using the AI based model (222). Furthermore, the method (300) includes validating by the network configuration system (102), if network performance output achieved in real-time using the feasible network configuration is compliant with an expected network performance for the communication intent (213). If the network performance output is validated to be compliant with the expected network performance, the method (300) includes inferring, by the network configuration system (102), the feasible network configuration as the optimal network configuration for enabling communication between the plurality of devices through at least one of the one or more data paths (215), in accordance with the communication intent (213) and the one or more network performance requirements. Further, if the network performance output is validated to be not compliant with the expected network performance, the method (300) includes rejecting, by the network configuration system (102), the feasible network configuration and iterating the steps of generating and validating until the determination of a subsequent feasible network configuration is compliant with the expected network performance for the communication intent (213).

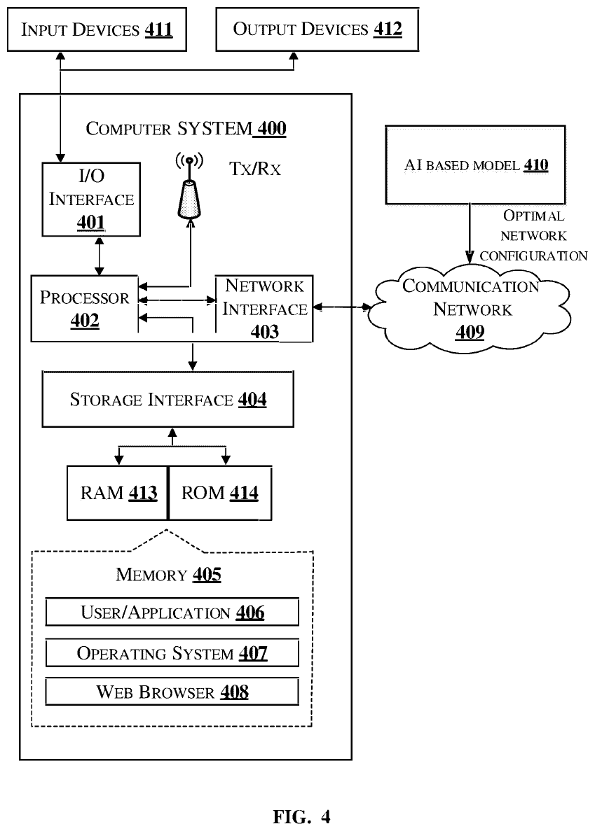

FIG. 4 illustrates a block diagram of an exemplary computer system (400) for implementing embodiments consistent with the present disclosure. In an embodiment, the computer system (400) may be a network configuration system (102) as illustrated in FIG. 2A, which may be used for determining an optimal network configuration for a communication network using an AI based model (410). The computer system (400) may include a central processing unit (“CPU” or “processor” or “memory controller”) (402). The processor (402) may comprise at least one data processor for executing program components for executing user- or system-generated business processes. The processor (402) may include specialized processing units such as integrated system (bus) controllers, memory controllers/memory management control units, floating point units, graphics processing units, digital signal processing units, etc.

The processor (402) may be disposed in communication with one or more Input/Output (I/O) devices (411) and (412) via I/O interface (401). The I/O interface (401) may employ communication protocols/methods such as, without limitation, audio, analog, digital, stereo, IEEE®-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE® 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface (401), the computer system (400) may communicate with one or more I/O devices (411) and (412).

In some embodiments, the processor (402) may be disposed in communication with a communication network (409) via a network interface (403). The network interface (403) may communicate with the communication network (409). The network interface (403) may employ connection protocols including, without limitation, direct connect, Ethernet (e.g., twisted pair 10/100/1000 Base T), Transmission Control Protocol/Internet Protocol (TCP/IP), token ring, IEEE® 802.11a/b/g/n/x, etc.

In an implementation, the communication network (409) may be implemented as one of the several types of networks, such as intranet or Local Area Network (LAN) and such within the organization. The communication network (409) may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP) etc., to communicate with each other. Further, the communication network (409) may include a variety of network devices, including routers, bridges, servers, computing devices, storage devices, etc. In an embodiment, the communication network (409) may be used for interfacing with one or more sources (104) for receiving one or more tickets.

In some embodiments, the processor (402) may be disposed in communication with a memory (405) (e.g., RAM (413), ROM (414), etc. as shown in FIG. 4) via a storage interface (404). The storage interface (404) may connect to memory (405) including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory (405) may store a collection of program or database components, including, without limitation, user/application interface (406), an operating system (407), a web browser (408), and the like. In some embodiments, the computer system (400) may store user/application data (406), such as the data, variables, records, etc. as described in this invention. Such databases may be implemented as fault-tolerant, relational, scalable, secure databases such as Oracle® or Sybase®.

The operating system (407) may facilitate resource management and operation of the computer system (400). Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM® OS/2®, MICROSOFT® WINDOWS® (XP®, VISTA®/7/8, 10 etc.), APPLE® IOS®, GOOGLE™ ANDROID™, BLACKBERRY® OS, or the like.

The user interface (406) may facilitate display, execution, interaction, manipulation, or operation of program components through textual or graphical facilities. For example, the user interface (406) may provide computer interaction interface elements on a display system operatively connected to the computer system (400), such as cursors, icons, check boxes, menus, scrollers, windows, widgets, and the like. Further, Graphical User Interfaces (GUIs) may be employed, including, without limitation, APPLE® MACINTOSH® operating systems' Aqua®, IBM® OS/2®, MICROSOFT® WINDOWS® (e.g., Aero, Metro, etc.), web interface libraries (e.g., ActiveX®, JAVA®, JAVASCRIPT®, AJAX, HTML, ADOBE® FLASH®, etc.), or the like.

The web browser (408) may be a hypertext viewing application. Secure web browsing may be provided using Secure Hypertext Transport Protocol (HTTPS), Secure Sockets Layer (SSL), Transport Layer Security (TLS), and the like. The web browsers (408) may utilize facilities such as AJAX, DHTML, ADOBE® FLASH®, JAVASCRIPT®, JAVA®, Application Programming Interfaces (APIs), and the like. Further, the computer system (400) may implement a mail server stored program component. The mail server may utilize facilities such as ASP, ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system (400) may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, and the like.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non volatile memory, hard drives, Compact Disc (CD) ROMs, Digital Video Disc (DVDs), flash drives, disks, and any other known physical storage media.

The present disclosure aims to automatically generate and validate network configuration in a communication network without any manual intervention leading to less engineering effort, and minimal manual errors. Further, because of storing the content of various network configuration data in the configuration database for various communication intents, the present disclosure enables the AI based model to self-learn and enhance the efficiency of generating an optimal network configuration. Further, in the present disclosure, as a similarity search is performed in the configuration database to find an existing configuration or in other words a historic network configuration which is compliant with the given communication intent and network topology, the network configuration system may detect either a compliant historic network configuration that can be directly implemented for the given communication intent and the network topology, or detects a historic network configuration that achieves a similar network performance output as required by the given communication intent. Therefore, when the network configuration required for the given communication intent is not available to be directly implemented, the present disclosure enables generating feasible network configurations based on the historic network configurations that are detected based on the similarity search in real-time, which are further validated in real-time until an optimal network configuration is determined. Therefore, the present disclosure enables the network configuration system to reduce time and resources consumed in generating an optimal network configuration in real-time for a given communication intent, as the network configuration system does not build the configuration from the beginning point, but uses the similar historic network configuration as a base point. This in turn eliminates delay in network communications as per the communication intent and also reduces unnecessary processing requirement while generating the network configuration. Further, by performing validation of the network configuration to determine an optimal network configuration, the present disclosure aims to determine an accurate network configuration in less time to achieve a communication intent.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

List of Reference Numbers

| Reference number | Description |
|---|---|
| 102 | Network configuration system |
| 104 | Configuration database |
| 106 | One or more user devices |
| 108, 409 | Communication network |
| 201 | I/O interface |
| 203 | Processor |
| 205 | Memory |
| 207 | Data |
| 209 | Modules |
| 211 | Network topology data |
| 213 | Communication intent |
| 215 | One or more data paths |
| 217 | Performance requirement data |
| 219 | Network configuration data |
| 221 | Auxiliary data |
| 222, 410 | AI based model |
| 223 | Receiving module |
| 225 | Network requirement determining module |
| 227 | Extracting module |
| 229 | Network configuration determining module |
| 231 | Auxiliary modules |
| 400 | Exemplary Computer system |
| 401 | I/O interface of an exemplary computer system |
| 402 | Processor of an exemplary computer system |
| 403 | Network interface of an exemplary computer system |
| 404 | Storage interface of an exemplary computer system |
| 405 | Memory of an exemplary computer system |

What is claimed is:

1. A method for determining an optimal network configuration for a communication network, comprising:
receiving, by a network configuration system, an input request comprising a network topology and a communication intent for facilitating communication between a plurality of devices;
determining, by the network configuration system, one or more network performance requirements and one or more data paths based on the communication intent and the network topology;
extracting, by the network configuration system, at least one historic network configuration related to the communication intent, the network topology and at least one of the one or more data paths and the one or more network performance requirements, from a configuration database associated with the network configuration system; and
using an Artificial Intelligence (AI) based model to determine, by the network configuration system, an optimal network configuration based on the at least one historic network configuration, for enabling communication between the plurality of devices through at least one or more data paths, in accordance with the communication intent and the one or more network performance requirements.

2. The method of claim 1, wherein determining the optimal network configuration comprises:
generating a feasible network configuration based on the at least one historic network configuration extracted from the configuration database in accordance with the communication intent and the one or more network performance requirements, using the AI based model; and
validating whether network performance output achieved in real-time using the feasible network configuration is compliant with an expected network performance for the communication intent.

3. The method of claim 2, further comprising inferring, by the network configuration system, the feasible network configuration as the optimal network configuration for enabling communication between the plurality of devices through at least one of the one or more data paths in accordance with the communication intent and the one or more network performance requirements when the network performance output is validated to be compliant with the expected network performance.

4. The method of claim 2, further comprising rejecting, by the network configuration system, the feasible network configuration and iterating the steps of generating and validating until the determination of a subsequent feasible network configuration is compliant with the expected network performance for the communication intent when the network performance output is validated to be not compliant with the expected network performance.

5. The method of claim 2, further comprising storing, by the network configuration system, content comprising at least one of the feasible network configuration generated for each iteration involved in determining the optimal network configuration and the optimal network configuration in the configuration database along with the corresponding communication intent the one or more network performance requirements, one or more data paths, and the network performance output; wherein the AI based model self-learns based on the content stored in the configuration database through every iteration involved in determining the optimal network configuration for that communication intent.

6. The method of claim 1, wherein the configuration database comprises a plurality of historic network configurations and the corresponding network performance requirements, the communication intent, the one or more data paths, and the network performance output.

7. The method of claim 1, further comprising generating the plurality of historic network configurations based on simulated network performance requirements and data paths for a plurality of simulated communication intents.

8. A network configuration system for determining an optimal network configuration for a communication network, the network configuration system comprising:
a processor; and
a memory;
wherein the memory stores processor-executable instructions, which, on execution, cause the processor to:
receive an input request comprising a network topology and a communication intent for facilitating communication between a plurality of devices;
determine one or more network performance requirements and one or more data paths based on the communication intent and the network topology;
extract at least one historic network configuration related to the communication intent, the network topology and at least one of the one or more data paths and the one or more network performance requirements, from a configuration database associated with the network configuration system; and
using an Artificial Intelligence (AI) based model to determine, based on the at least one historic network configuration, an optimal network configuration for enabling communication between the plurality of devices through at least one of the one or more data paths, in accordance with the communication intent and the one or more network performance requirements.

9. The network configuration system of claim 8, wherein determining the optimal network configuration comprises:
generating a feasible network configuration based on the at least one historic network configuration extracted from the configuration database in accordance with the communication intent and the one or more network performance requirements, using the AI based model; and
validating whether network performance output achieved in real-time using the feasible network configuration is compliant with an expected network performance for the communication intent.

10. The network configuration system of claim 9, wherein based on the outcome of the validation, the processor is configured to infer the feasible network configuration as the optimal network configuration for enabling communication between the plurality of devices through at least one of the one or more data paths in accordance with the communication intent and the one or more network performance requirements when the network performance output is validated to be compliant with the expected network performance.

11. The network configuration system of claim 10, wherein based on the outcome of the validation, the processor is configured to reject the feasible network configuration and iterating the steps of generating and validating until the determination of a subsequent feasible network configuration is compliant with the expected network performance for the communication intent when the network performance output is validated to be not compliant with the expected network performance.

12. The network configuration system of claim 9, wherein the processor is further configured to store content comprising at least one of the feasible network configuration generated for each iteration involved in determining the optimal network configuration and the optimal network configuration in the configuration database along with the corresponding communication intent, the one or more network performance requirements, one or more data paths, and the network performance output, wherein the AI based model self-learns based on the content stored in the configuration database through every iteration involved in determining the optimal network configuration for that communication intent.

13. The network configuration system of claim 8, wherein the configuration database comprises a plurality of historic network configurations and the corresponding network performance requirements, the communication intent, the one or more data paths, and the network performance output.

14. The network configuration system of claim 8, wherein the processor is further configured to generate the plurality of historic network configurations based on simulated network performance requirements and data paths for a plurality of simulated communication intents.
